(19) United States
(12) Patent Application Publication
(10) Pub. No.: US 2002/0194343 A1
(43) Pub. Date: Dec. 19, 2002

(54) Measurement of time-delay, time-delay-variation, and cell transfer rate in ATM networks

(76) Inventors: Kishan Shenoi, Saratoga, CA (US); Gary Jacobsen, San Jose, CA (US); Kamila Kraba, Santa Clara, CA (US); Chien-Chou Lai, Sunnyvale, CA (US); Jeremy Sommer, Mountain View, CA (US); Jining Yang, Sunnyvale, CA (US)

Correspondence Address: JOHN J. BRUCKNER, FULBRIGHT & JAWORSKI, 600 CONGRESS AVENUE, SUITE 2400, AUSTIN, TX, 78701, US

(21) Appl. No.: 09/993,302

(22) Filed: Nov. 14, 2001

Related U.S. Application Data
(60) Provisional application No. 60/272,413, filed on Feb. 28, 2001.

(51) Int. Cl. G06F 15/16

(52) U.S. Cl. 709/227; 709/230

(57) ABSTRACT

Systems and methods are described for the measurement of time delay, time delay variation and cell transfer rate in asynchronous transfer mode networks. A method includes generating a time-stamp information cell at a first location; transmitting the time-stamp information cell to a second location via a network link; and receiving the time-stamp information cell at the second location. An apparatus includes an asynchronous transfer mode network including a time delay information cell generator.

### CROSS-REFERENCE TO RELATED APPLICATION

This application is related to, is a divisional/continuation[-in-part] of, and claims a benefit of priority under 35 U.S.C. 119(e) and/or 35 U.S.C. 120 from, copending U.S. Ser. No. 60/272,413, filed Feb. 28, 2001, now pending, the entire contents of which are hereby expressly incorporated by reference for all purposes.

### BACKGROUND OF THE INVENTION

1. Field of the Invention

The invention relates generally to the field of computer networks. More particularly, the invention relates to private computer networks based on asynchronous transfer mode technology. Specifically, a preferred implementation of the invention relates to a measurement of a time-delay, a time-delay variation, and a cell transfer rate in an asynchronous transfer mode network.

2. Discussion of the Related Art

Asynchronous Transfer Mode (ATM) is a popular technology for providing secure and reliable Virtual Private Network arrangements. The use of ATM Switches permits the Service Provider (such as an Inter-Exchange Carrier, or “IXC”) to better utilize the inter-machine trunking facilities by providing trunk bandwidth only when there are ATM cells available for transmission. This is in contrast with the notion of a (truly) Private Network wherein the Service Provider is required to dedicate the prescribed bandwidth for the end customer in all inter-machine trunking facilities provisioned for the connection.

Consider, for example, an end-user that requires a Private Network linking three separate locations, A, B, and C. Assume that a 56 kbps connection is required between each pair of locations. One approach to providing this service is to have dedicated 56 kbps access links between the customer premises and the Service Provider Network (often called the “cloud”). Each location would have two such dedicated “DDS” (Digital Data Service) links. The Service Provider would use Digital Access and Cross-connect Systems (“DACS”) to manage the private network. The “cloud” could then be visualized as a multitude of such DACS machines interconnected by trunks. These trunks are usually DS1 links that may be further amalgamated into DS3 or SONET multiplexed assemblies for transmission over long haul facilities. Each 56 kbps link is treated as a DS0 and the DACS machines ensure that each 56 kbps link is maintained across the Network by establishing the correct cross-connections. Fundamentally, a 56 kbps link between points A and B require that all intervening DACS machines be appropriately provisioned and that a DS0 be reserved in all intervening facilities for that particular link. This reserved DS0 represents bandwidth unavailable for any other use. The advantages (to the end-user) of such an arrangement are privacy and availability.

Referring to FIG. 1, an example of a conventional virtual private network is shown where the 56-kbps link between A and C is treated as a DS0 (a DS0 is a 64 kbps channel). One DS0 in the inter-machine trunk labeled IMT-A that interconnects DACS machines D-1 and D-2 is reserved for the link and the cross-connect maps in D-1 and D-2 ensure the connectivity. Since each DS0 is a “time-slot” within a DS1, the networking method is referred to as TDM (time division multiplexing). Similarly, the link between A and B requires that a DS0 be dedicated in IMT-B and IMT-D and the cross-connect maps in D-1, D-3 and D-4 must be coordinated to ensure connectivity. Likewise, the link between B and C requires the reservation of DS0s in IMT-C and IMT-D and the coordination of cross-connect maps in D-2, D-3, and D-4.

Clearly, the access method can be enhanced to DS1 (“T1”) whereby the two 56 kbps links at a location are assigned to two DS0s in the access DS1. With DS1 (1.544 Mbps) access, the same form of Network (DACS machines interconnected by high-speed trunks) can be deployed to provide links of the form Nx64 kbps or Nx56 kbps by utilizing multiple DS0s per link (N is between 1 and 24, inclusive).

The example depicted in FIG. 2 represents a situation where there is a 8×64=512 kbps link between A and C, a 6×64=384 kbps link between C and B, and a 12×64=784 kbps link between B and A. The corresponding bandwidth must be reserved on the various IMTs connecting the DACS machines. Clearly, no single link in the above example can be greater than 24×64=1536 kbps since we are assuming DS1 access.

A problem with this technology has been that the bandwidth is wasted when there is no data available for transmission. The DSU/CSU used at the customer premise to drive the access segment will fill in null data (such as flags or equivalent fill-in units) to maintain the synchronous data rate (1.544 Mbps). The Service Provider network is unaware of such idle data fill-in units and the associated bandwidth is thus required to transport such useless data across the cloud. Generally speaking, in a TDM-based private network, connectivity is provided at the bit level; in the cloud no determination is made as to whether the bits being transported correspond to actual data or to fill-in units.

The use of ATM technology allows the sharing of access and inter-machine trunks by multiple (logical) links. The underlying premise of ATM is that a data stream can be segmented into cells. The ATM standard calls out for cells that contain 48 bytes of user data. Appended to each cell are 5 bytes of overhead that includes an identifier of the destination. This identifier is encapsulated as a combination of “VPI” and “VCI” (for Virtual Path Identification and Virtual Channel Identification). Instead of the DACS machines in the prior example, ATM Switches are deployed and the inter-machine and access trunks carry cells rather than channelized information. The equivalent of cross-connection is performed by the ATM Switches on a cell-by-cell basis, using the VPI/VCI as the underlying pointer to match the ingress and egress trunks from the Switch. A Permanent Virtual Circuit (PVC) is established by provisioning the intervening ATM Switches between the two (or more) points of customer (end-user) access into the ATM cloud. In the configuration of three end-user locations considered above, cells from location A destined to location B will have a prescribed VPI/VCI in the cell-overhead when launched from location A. The 48 bytes of user-data are transported across the cloud though the cell header may be modified. Cells associated with a specific PVC will always traverse the same route and thus cell sequencing is not an issue. If there is no data available for transmission, the access multiplexer will insert “filler” cells to maintain the synchronous transmission rate of the access link but these filler cells can be discarded by the network. This arrangement is depicted in FIG. 3.

It is certainly possible to create private networks wherein the Network Service Provider maintains TDM links between the various access multiplexers and the ATM (or equivalent) switching capability resides in the CPE (customer premises equipment). This form of private networking is quite common and, more often than not, the TDM links between multiplexers are T1 links and the access multiplexers in this situation are referred to as T1 multiplexers.

Whereas in TDM-based network arrangements the address or identity of a link is defined by its position (in time) within the DS1 stream, in an ATM-based network the address of the destination is encoded appropriately by the access multiplexer on a cell-by-cell basis. Thus at Location A, data (cells) destined for Location B will be assigned a VPI/VCI, say “a”. Likewise access multiplexers in all locations are assigned VPI/VCI codes for each of their PVCs depending on the end-points of the PVC (they do not have to be the same code at the two end points). The ATM Switches D-1 and D-2 are programmed such that a cell from Location A with VPI/VCI=“a” will be delivered to Location C and the VPI/VCI there may be “c”. Whereas it is natural to establish the “shortest” path for a link, there is no fundamental restriction to that effect. In fact, the link between A and C may be established by creating a permanent virtual circuit that traverses D-3 as an intermediate step.

Inter-machine trunks can thus carry cells associated with a multiplicity of virtual circuits. Since the bandwidth is used on an “as-needed” basis, the utilization of inter-machine trunks can be optimized on a statistical basis. The drawback is that at times of peak loading, congestion could occur. To best utilize transmission bandwidth, it is commonplace to have buffers to “smooth” the traffic at all switch-trunk interfaces.

A problem with this technology has been that the presence of buffers introduces delay, and the statistical nature of traffic causes the actual delay to vary about some nominal mean value. In an ideal situation this delay would be fixed (and as small as possible). Whereas delay, and delay-variation, is of less consequence when the data consists of inter-computer communication, the significance is much greater when the data consists of real-time traffic such as voice or video. The Service Provider is supposed to guarantee a certain level of service, often quantified as a QoS (Quality of Service) description that includes, among other quality parameters, the notion of delay and delay-variation.

Heretofore, the requirements of accurately measuring the time-delay, time-delay variations, and cell transfer rates in a cost effective manner to quantify the QoS referred to above have not been fully met. What is needed is a solution that simultaneously addresses all of these requirements.

### SUMMARY OF THE INVENTION

There is a need for the following embodiments. Of course, the invention is not limited to these embodiments.

According to a first aspect of the invention, a method comprises: generating a time-stamp information cell at a first location; transmitting the time-stamp information cell to a second location via a network link; and receiving the time-stamp information cell at the second location. According to a second aspect of the invention, an apparatus comprises: an asynchronous transfer mode network including a time delay information cell generator.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein like reference numerals (if they occur in more than one view) designate the same elements. The invention may be better understood by reference to one or more of these drawings in combination with the description presented herein. It should be noted that the features illustrated in the drawings are not necessarily drawn to scale.

FIG. 1 illustrates a block diagram of a TDM-based private network, appropriately labeled “PRIOR ART.”

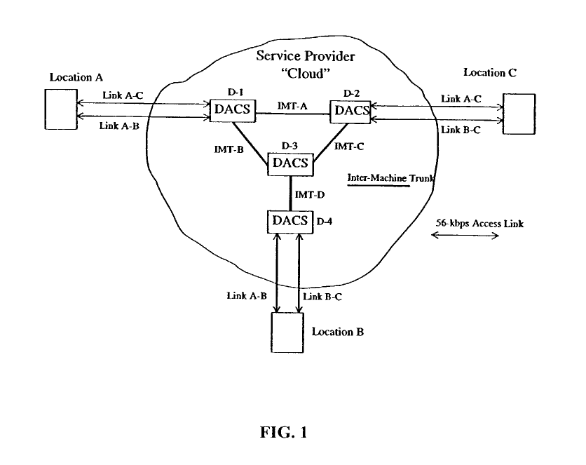

FIG. 2 illustrates a block diagram of another TDM-based private network, appropriately labeled “PRIOR ART.”

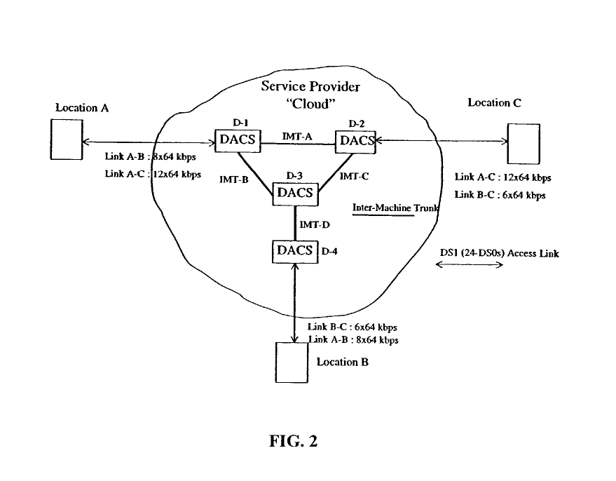

FIG. 3 illustrates a block diagram of an ATM-based private network, appropriately labeled “PRIOR ART.”

FIG. 4 illustrates a block diagram of ATM functions, appropriately labeled “PRIOR ART.”

FIG. 5 illustrates a flow diagram of a time-stamp generation process, representing an embodiment of the invention.

FIG. 6 illustrates a block diagram of the basic structure of a TDV Cell, representing an embodiment of the invention.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known components and processing techniques are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this detailed description.

Within this application one or more publications are referenced by Arabic numerals within parentheses or brackets. Full citations for these, and other, publications may be found at the end of the specification immediately preceding the claims after the section heading References. The disclosures of all these publications in their entireties are hereby expressly incorporated by reference herein for the purpose of indicating the background of the invention and illustrating the state of the art.

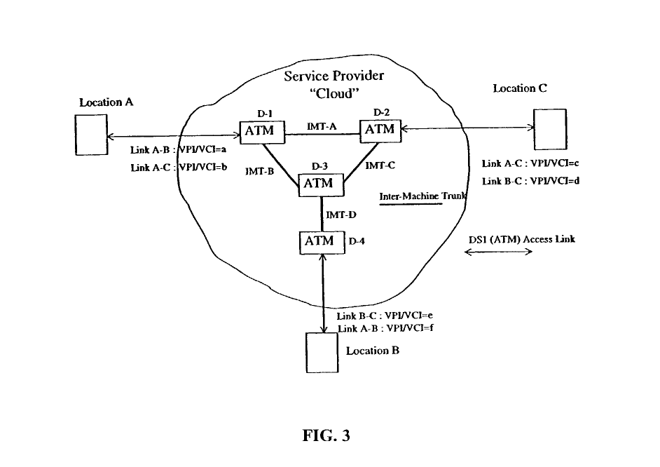

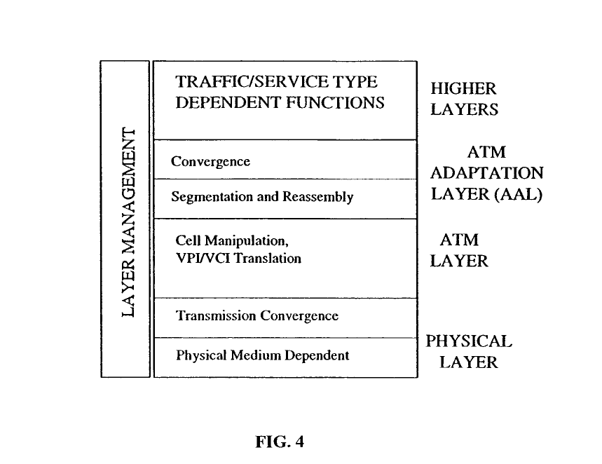

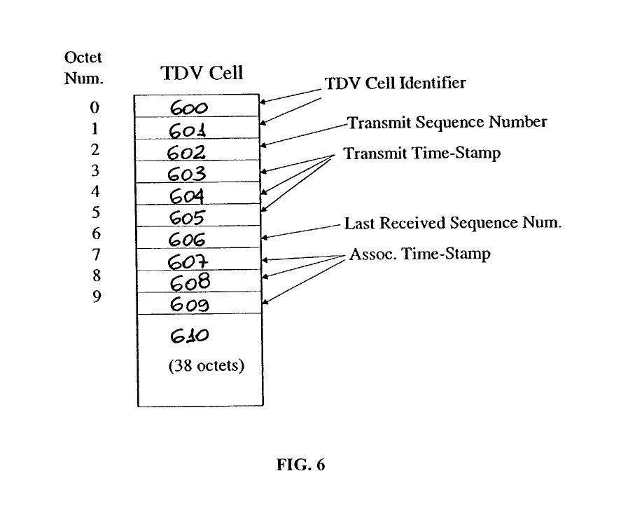

The premise underlying ATM encapsulation is that a serial data stream can be segmented into cells. These cells are comprised of 48 byte (octet) blocks. For transmission over the physical layer (which could be DS1, DS3, SONET, ADSL, SDSL, etc.) a 5 octet header is added to make the transmission unit 53 octets in size. It is convenient to look at the arrangement in terms of functional layers as depicted in FIG. 4 which is a simplified view of the layered description provided in the literature (e.g. Ref. [1], FIG. 3.14, FIG. 6.1).

Referring to FIG. 4, the notion of “Higher Layers” refers to the manner in which information (data) is handled at the application layer. For example, the source of data may be computer generated, destined as a file transfer to another location (computer); the source of data may be a telephone/PBX as in a voice call between this and another location. These higher layers generate the data that need to be transported over the Network. The kind of data, or service required, could be time-critical, such as voice where an essentially continuous data rate must be maintained, or file transfers where real time is not so significant.

This data is presented to the ATM Adaptation Layer (AAL) for proper formatting into the 48 octet cells. The “Convergence sub-layer” aspect of the AAL refers to any particular actions that must be taken to match the data source and the method of transmission. The data is presented in the form of serial data or, equivalently, in the form of octets. Depending on the Service the formatting into 48 octet cells is done differently, with a different amount of the 48-octet cell payload being used for actual user data (see Ref. [1], FIG. 6.1, for example). For instance, the 48-octet assembly may include some additional overhead required to properly reassemble the actual user data bit-stream (octet-stream) at the receiver. Nevertheless, the ATM Adaptation Layer (AAL) provides the ATM layer information in the form of 48-octet cells (for each individual link) and, likewise, accepts 48-octets units (for each individual link). Thus the AAL includes the functions of segmentation and reassembly (SAR) in the outbound and inbound directions, respectively.

The ATM Layer comprises the functions associated with cell processing. This would include the generation/extraction of the 5-octet header, the insertion/translation of the appropriate VPI/VCI, generic flow control, and the multiplex/demultiplex operations. A VPI (virtual path identification) identifies a unidirectional transport of ATM cells belonging to a bundle of virtual channels. A VCI (virtual channel identification) describes a unidirectional transport of ATM cells.

The Physical Layer can be viewed as two sub-layers. The transmission convergence sublayer refers to the functions of mapping ATM cells (53-octet units) into a format suitable for transmission over the given physical medium (such as DS1, DS3, etc.). Likewise, in the inbound direction, cell delineation, whereby the 53-octet units are extracted from the received signal, is performed. The Physical Medium dependent sub-layer is where the transmit bit-stream is generated and inbound bit-stream extracted. Also, pulse wave-shapes appropriate for the physical medium are generated (outbound) or detected (inbound).

The method for measuring time delay and time delay variation involves the sending of specially marked cells that contain time-stamps. The notion of a time stamp is quite straightforward and is simple to implement.

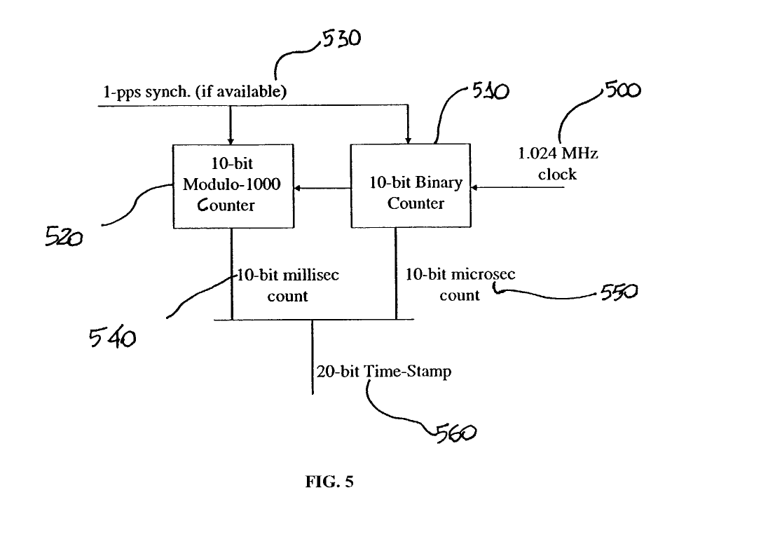

Referring to FIG. 5, a 1.024 MHz clock signal 500 is coupled to a 10-bit binary counter 510. The 10-bit binary counter 510 is coupled to a 10-bit modulo-1000 counter 520. A 1-pps synchronization signal 530 is coupled to the 10-bit modulo-1000 counter 520 and to the 10-bit binary counter 510. The 10-bit modulo-1000 counter 520 is coupled to a 10-bit millisecond count 540. The 10-bit binary counter 510 is coupled to a 10-bit microsecond count 550. The 10-bit millisecond count 540 is coupled to a 20-bit time stamp 560. The 10-bit microsecond count 550 is coupled to the 20-bit time stamp 560.

Still referring to FIG. 5, the access multiplexer includes a counter driven by its local master clock. This master clock must be reasonably accurate or, preferably, synchronized in frequency to the Network time-base. For example, assume that the access multiplexer has available (internally) the 1.024 MHz clock signal 500. Assume that the counter is a 16-bit binary counter. Then each count represents a time interval of 0.977 μsec (approximately 1 μsec) and the counter “roll-over” occurs every 65536 counts, or 64 msec. The value of the counter represents time modulo-64-msec. In a serially casacaded arrangement, the counter is split into two counters, the 10-bit binary counter 510 and the other the 10-bit modulo-1000 counter 520. Then the 10-bit binary counter 510 roll-over occurs every 1 msec and by using the roll-over as the count-enable for the modulo-1000 counter 520, the total arrangement rolls-over every 1 sec. The combined 20-bit value represents time modulo-1-sec. The latter arrangement is especially suitable if the access multiplexer has available a time-synchronization signal such as the 1 pps synchronization signal 530 (1 pulse-per-second) that is synchronized to absolute time (UTC or Universal Coordinated Time). Availability of a 1-pps synchronization signal 530 allows us to synchronize the dual-counter arrangement such that the roll-over occurs in a coordinated manner in all such multiplexers (wherever they may be). If a 1-pps signal is available, the time-stamp 560 is thus “absolute”; if such a 1-pps signal is not available then the time-stamp 560 is “relative”.

Referring to FIG. 3, the availability of this counter value, or time-stamp, means that the arrival time of a cell can be recorded. Likewise, the time of creation of a cell can be recorded. The time-stamp 560, in the given example of counters, can be stored as a 3-octet number.

Clearly, a Time-Stamp counter can easily be modified to generate a Time-Stamp occupying 3 octets and have a much higher modulo-time, for example 16 seconds. The special cells used to transmit Time-Stamp information will be referred to as “TDV Cells”. The contents of the 48-octet TDV Cell are described here.

First, there has to be some qualification that the cell is indeed a TDV Cell. For example, 2 (or more) octets with a special pattern can be used for this purpose. Second, the transmitter will assign a sequence number to the cell it is sending. For example, one octet will permit sequence numbering modulo-256 (the sequence number following 255 is 0). Third is the Time-Stamp that represents the “instant” that this cell is created, i.e., readied for transmission. Three octets suffice if the Time-Stamp scheme of FIG. 5 is employed. The combination of sequence number and Time-Stamp is 4 octets and is referred to as a Time-Stamp Unit. At the transmitter, the time-stamp is representative of the time-of-transmission of the cell. At the receiver, the Time-Stamp Unit is modified such that the time-stamp is representative of the time-of-arrival of the cell.

Fourth, and this is crucial in the case of relative Time-Stamps, the transmitter returns the last Time-Stamp Unit that it received from the other end of the link (the far end access multiplexer).

The information as described so far utilizes 10 (2+4+4) octets of the available 48. Two octets for identification as a TDV Cell, 4 octets for the transmission Time-Stamp Unit, and 4 octets comprising the last received Time-Stamp unit (a transmission Time-Stamp unit originating at the far end access multiplexer modified such that the time-stamp is representative of the time-of-arrival). Additional useful information that could be accommodated in the remaining 38 octets will be discussed later.

Referring to FIG. 6, the basic structure of a TDV Cell is depicted. An octet number 0 block 600 is coupled to an octet number 1 block 601. The octet number 1 block 601 is coupled to an octet number 2 block 602. The octet number 2 block 602 is coupled to an octet number 3 block 603. The octet number 3 block 603 is coupled to an octet number 4 block 604. The octet number 4 block 604 is coupled to an octet number 5 block 605. The octet number 5 block 605 is coupled to an octet number 6 block 606. The octet number 6 block 606 is coupled to an octet number 7 block 607. The octet number 7 block 607 is coupled to an octet number 8 block 608. The octet number 8 block 608 is coupled to an octet number 9 block 609. The octet number 9 block 609 is coupled to a 38 octet block 610.

Still referring to FIG. 6, the octet number 0 block 600, and the octet number 1 block 601 can contain a TDV cell identifier. The octet number 2 block 602 can contain a transmit sequence number. The octet number 3 block 603, the octet number 4 block 604, and the octet number 5 block 605 can contain a transmit time-stamp. The octet number 6 block 606 can contain a last received sequence number. The octet number 7 block 607, the octet number 8 block 608 and the octet number 9 block 609 can contain an associated time-stamp (representative of time-of-arrival). The 38-octet block 610 can contain additional useful information.

The access multipler will routinely send TDV Cells to the distant end access multiplexer. To avoid confusion caused by the modulo-1-sec representation of time, the interval between TDV Cell transmissions should be less than 1 second (preferably less than 0.5 or even 0.25 seconds). Furthermore, the absolute time delay of the link should be less than 1 second. If these conditions cannot be met for some reason, then the Time-Stamp generation requires a higher “roll-over” or modulo-time. Since there is an adequate number of octets available in a cell, representation of a Time-Stamp using more than 3 octets is easily accommodated. However, we shall assume for this explanation that time is modulo-1-second and 3 octets are used for the Time-Stamp.

Based on the record of transmit time epoch and received time epoch, the access multiplexer can ascertain the time-delay variation over the link. If the two access multiplexers at the ends of the link (say A and B) are synchronized to UTC (absolute Time-Stamps) then the actual time delay over the link can be estimated.

The time-stamp information cell can be generated at a first access multiplexer (where it will include a transmittal time-stamp), transmitted to a second access multiplexer (where it may get a receive time-stamp), and then be re-transmitted to the first access multiplexer. In this case, the information contained in the cell arriving at the first access multiplexer would provide the original transmission time and the time of arrival at the second multiplexer.

Assuming that the local master clocks of the two access multiplexers are accurate, for example via synchronization of time-base with the Network time-base, then the Time-stamps generated at the same instant of time at the two ends will be offset by a constant value, say X, which is not known but is constant. If the two ends have UTC traceability, then we can assume that X is zero (or a known value). If the transmit (from A) time-stamp is T₁ and the receive (at B) time-stamp is T₂, then the difference ((T₂−T₁)), where the difference is taken modulo-1-sec [the use of double parentheses commonly denotes a modulo operation], is a measure of the time-delay across the link from A to B, offset by X. By keeping a record of such time-difference measurements, where each measurement has the same (unknown) offset, X, we can develop a histogram, or profile, of the time delay across the link from A to B. A similar operation is performed at the other end to gauge the delay characteristics of the link from B to A.

Assume we have made N measurements of this time delay, and denote these values by {xₖ; k=0, 1, . . . ,(N−1)}. The standard deviation of this set of numbers is a measure of the time-delay-variation (TDV) of the link from A to B. The average of these values is an estimate of the time-delay (on the average) of the link from A to B. In particular,

$$\overline{x} = \frac{1}{N} {\sum }_{k = 0}^{N - 1} {x}_{k} = average time \text{-} delay$$

$${σ}_{AB}^{2} = \frac{1}{N - 1} {\sum }_{k = 0}^{N - 1} {( {x}_{k} - \overline{x} )}^{2} = estimate of TDV variance$$

σ_{AB}=\sqrt{σ_{AB}²}=estimate of standard deviation of TDV

Δ_{AB}=max{xₖ}−min{xₖ}=estimate of max. TDV

max{xₖ}=largest{xₖ;k=0, 1, . . . ,(N−1)}

This estimate of average time-delay is useful when the two ends are UTC traceable. The estimate of time-delay variation is useful when the two end multiplexers have accurate master clocks (frequency).

Now suppose we have two PVCs between the same two end-points and we denote by {xₖ} the time-delay measurements on PVC #1 and by {yₖ} the time-delay measurements on PVC #2. Since the two PVCs have the same end-point access multiplexers, the fixed time-offset, X, discussed before, is the same for both sets of measurements. We can determine a “worst-case” time-delay variation between the two PVCs by considering

Δ_{AB}^{1,2}=max{[max{xₖ}−min{yₖ}], [max{yₖ}−min{xₖ}]}

If the two or more PVCs are “bonded” together, this worst-case time-delay variation is useful for determining the size of the buffers required to re-sequence cells from a single stream that are “split” between the two or more PVCs.

What if the access multiplexer at A never receives a TDV cell containing the time of reception at B of a particular cell with sequence number M? This would indicate that the TDV Cell from A to B did not appear at B or the corresponding TDV Cell from B did not reach A. Based on sequence numbers available it is not difficult to ascertain which direction had the trouble. A cell is lost if there is significant traffic congestion in the Network to the point that the Network is discarding cells, or a transmission error occurred, based on which the cell was discarded. In either case, the loss of cells is an indication of deteriorating quality of service.

For the method to have value, the TDV Cells must traverse exactly the same path as the user data over the Network. One way to ensure this is to map TDV Cells as well as the user-data cells into the same VPI/VCI. The disadvantage to this approach is that every cell, whether it contains user-data or is a TDV Cell, must reserve some portion of the 48-octet arrangement to identify it as such. However, the “tax” this imposes is not steep and the advantages of being able to monitor the permanent virtual circuit (PVC) would more than compensate for this reduction in bandwidth. Furthermore, since the TDV Cells occupy the same PVC anyway, this tax has minimal negative consequences.

An alternative method is to assign two VPI/VCI between the two end points and administratively assure that traffic for both PVCs traverse exactly the same ATM Switches and inter-machine trunks. Since the end points of both PVCs are the same, this administrative burden is minimal. In this method, the “tax” levied on user-data cells to distinguish them from TDV Cells is non-existent.

As mentioned above, there are an ample number of octets available in TDV Cells for other uses. One possible use is to ascertain the cell transfer rate being achieved over the particular PVC being monitored. In particular, the access multiplexer maintains a count of cells being transmitted over the PVC. This count can be modulo-N where N is a large number, say 65536=2¹⁶, so the count can be represented by a 16-bit unsigned integer and encapsulated in two octets.

The transmit access multiplexer includes the current cell count in each TDV Cell. The receiver can, from two consecutive TDV Cells, ascertain the number of cells that have been transmitted in the time interval between the transmission of the two cells as well as ascertain the time interval between the two cells from the two time-stamps. Assuming that TDV Cells are transmitted reasonably frequently (at least two TDV Cells in every N cells, preferably four or eight TDV Cells in every N cells), then the roll-over associated with the modulo-N numbering can be easily resolved, even if an occasional TDV Cell is lost in transit.

The nominal cell transfer rate is then easily computed as the number of cells transmitted divided by the time-interval.

The context of the invention can include asynchronous transfer mode network characterization. The context of the invention can also include time-delay measurements and estimates, time-delay variation measurements and estimates, and cell transfer rate measurements and estimates.

The invention can also be included in a kit. The kit can include some, or all, of the components that compose the invention. The kit can be an in-the-field retrofit kit to improve existing systems that are capable of incorporating the invention. The kit can include software, firmware and/or hardware for carrying out the invention. The kit can also contain instructions for practicing the invention. Unless otherwise specified, the components, software, firmware, hardware and/or instructions of the kit can be the same as those used in the invention.

The term approximately, as used herein, is defined as at least close to a given value (e.g., preferably within 10% of, more preferably within 1% of, and most preferably within 0.1% of). The term substantially, as used herein, is defined as at least approaching a given state (e.g., preferably within 10% of, more preferably within 1% of, and most preferably within 0.1% of). The term coupled, as used herein, is defined as connected, although not necessarily directly, and not necessarily mechanically. The term deploying, as used herein, is defined as designing, building, shipping, installing and/or operating. The term means, as used herein, is defined as hardware, firmware and/or software for achieving a result. The term program or phrase computer program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system. The terms including and/or having, as used herein, are defined as comprising (i.e., open language). The terms a or an, as used herein, are defined as one or more than one. The term another, as used herein, is defined as at least a second or more.

### Practical Applications of the Invention

A practical application of the invention that has value within the technological arts is time-delay measurements, time-delay variance measurements and cell transfer rate measurements in asynchronous transfer mode networks. There are virtually innumerable uses for the invention, all of which need not be detailed here.

### Advantages of the Invention

Time-delay measurements, time-delay variance measurements and cell transfer rate measurements in asynchronous transfer mode networks, representing an embodiment of the invention, can be cost effective and advantageous for at least the following reasons. The invention can provide statistically significant performance data relating to the host ATM system, as well as specific routing configurations thereof. The invention improves quality and/or reduces costs compared to previous approaches.

All the disclosed embodiments of the invention disclosed herein can be made and used without undue experimentation in light of the disclosure. Although the best mode of carrying out the invention contemplated by the inventors is disclosed, practice of the invention is not limited thereto. Accordingly, it will be appreciated by those skilled in the art that the invention may be practiced otherwise than as specifically described herein. Further, the individual components need not be combined in the disclosed configurations, but could be combined in virtually any configuration.

Further, although the time-delay measurements, time-delay variance measurements and cell transfer rate measurements in asynchronous transfer mode networks described herein can be a separate module, it will be manifest that the time-delay measurements, time-delay variance measurements and cell transfer rate measurements in asynchronous transfer mode networks may be integrated into the system with which they are associated. Furthermore, all the disclosed elements and features of each disclosed embodiment can be combined with, or substituted for, the disclosed elements and features of every other disclosed embodiment except where such elements or features are mutually exclusive.

It will be manifest that various substitutions, modifications, additions and/or rearrangements of the features of the invention may be made without deviating from the spirit and/or scope of the underlying inventive concept. It is deemed that the spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

### REFERENCES

1. Walter J. Goralski, “Introduction to ATM Networking,” McGraw-Hill Series on Computer Communications, 1995. ISBN 0-07-024043-4.

What is claimed is:

1. A method, comprising:
generating a time-stamp information cell at a first location;
transmitting the time-stamp information cell to a second location via a network link; and
receiving the time-stamp information cell at the second location.

2. The method of claim 1, further comprising synchronizing the first location and the second location with a coordinated time.

3. The method of claim 1, wherein generating the time-stamp information cell includes generating the time-stamp information cell utilizing a time-stamp generator.

4. The method of claim 1, wherein generating the time-stamp information cell includes generating a 20-bit time-stamp information cell.

5. The method of claim 1, wherein generating the time-stamp information cell at a first location includes generating a time-stamp information cell at a first access multiplexer located at a beginning of the network link.

6. The method of claim 5, wherein receiving the time-stamp information cell at a second location includes receiving a time-stamp information cell at a second access multiplexer located at an end of the network link.

7. The method of claim 1, wherein transmitting the time-stamp information cell to the second location via the network link includes transmitting the time-stamp information cell to the second location via an asynchronous transfer mode network link.

8. The method of claim 1, wherein transmitting the time-stamp information cell includes transmitting the time-stamp information cell mapped with a same virtual path identification as a data cell.

9. The method of claim 1, wherein transmitting the time-stamp information cell includes transmitting the time-stamp information cell mapped with a same virtual channel identification as the data cell.

10. The method of claim 1, further comprising:
re-transmitting the time-stamp information cell back to the first location via the network link; and
receiving the time-stamp information cell at the first location.

11. The method of claim 10, wherein re-transmitting the time-stamp information cell includes adding a last received sequence number to the time-stamp information cell and transmitting the time-stamp information cell.

12. The method of claim 10, wherein re-transmitting the time-stamp information cell includes adding a last received sequence number associated time-stamp to the time-stamp information cell and transmitting the time-stamp information cell.

13. The method of claim 10, wherein re-transmitting the time-stamp information cell includes transmitting the time-stamp information cell mapped with the same virtual path identification as the data cell.

14. The method of claim 10, wherein re-transmitting the time-stamp information cell includes transmitting the time-stamp information cell mapped with the same virtual channel identification as the data cell.

15. The method of claim 1, wherein generating a time-stamp information cell includes:
providing a cell containing a plurality of octets;
utilizing a first set of the plurality of octets to hold an identifier;
utilizing a second set of the plurality of octets to hold a transmit sequence number;
utilizing a third set of the plurality of octets to hold a transmit time-stamp;
utilizing a fourth set of the plurality of octets to hold a last received sequence number; and
utilizing a fifth set of the plurality of octets to hold a last received sequence number associated time-stamp.

16. The method of claim 1, further comprising:
calculating a time-delay utilizing the time-stamp information cell;
building a time-delay distribution array;
calculating a time-delay variance utilizing the time-delay distribution array; and
calculating a cell-transfer rate utilizing a time-delay distribution array.

17. The method of claim 16, wherein calculating includes estimating.

18. A computer program, comprising computer or machine readable program elements translatable for implementing the method of claim 1.

19. An apparatus for performing the method of claim 1.

20. An electromagnetic waveform produced by the method of claim 1.

21. An electronic media, comprising a program for performing the method of claim 1.

22. An apparatus, comprising an asynchronous transfer mode network including a time delay information cell generator.

23. The apparatus of claim 22, further comprising a memory containing a plurality of time delay information cells.

24. The apparatus of claim 22, wherein the plurality of time delay information cells include a copy of a transmitted time delay-information cell.

25. The apparatus of claim 22, wherein the plurality of time delay information cells include a received time delay information cell.

26. The apparatus of claim 22, wherein the time information cell generator includes:
a main clock;
a set of counters coupled to the main clock;
a synchronization signal source coupled to the set of counters; and
a time-stamp signal coupled to the set of counters.

27. The apparatus of claim 26, wherein the set of counters includes a plurality of counters that are serially cascaded.
